(19) United States
(12) Patent Application Publication
(10) Pub. No.: US 2010/0044061 A1
(43) Pub. Date: Feb. 25, 2010

(54) VIBRATORY PLOW ASSEMBLY

(75) Inventors: Oral Robert Harvey, Leighton, IA (US); Ted Jay Sanders, Chariton, IA (US)

Correspondence Address: MERCHANT & GOULD PC, P.O. BOX 2903, MINNEAPOLIS, MN, 55402-0903, US

(73) Assignee: VERMEER MANUFACTURING COMPANY, Pella, IA (US)

(21) Appl. No.: 12/261,961

(22) Filed: Oct. 30, 2008

Related U.S. Application Data
(60) Provisional application No. 61/090,490, filed on Aug. 20, 2008.

(51) Int. Cl. A01B 11/00

(52) U.S. Cl. 172/40; 405/182

(57) ABSTRACT

The present disclosure generally relates to a method and apparatus for installing utility lines underground by using a vibratory plow. One aspect of the invention relates to using a resilient member attached to a vibrator assembly, where the resilient member stores the kinetic energy of the vibrator assembly downward movement. The kinetic energy is then released during the upward movement. The energy is applied to a plow blade so as to improve the efficiency of the plow blade as it is drawn through the ground. Another aspect of the invention relates to connecting the resilient member to the ground via a set of wheels that do not appreciably deflect during the downward movement.

### CROSS-REFERENCE TO RELATED APPLICATION

This application claims priority to provisional application No. 61/090,490 filed Aug. 20, 2008, entitled Vibratory Plow Assembly, which is incorporated by reference in its entirety herein.

### FIELD OF THE INVENTION

This disclosure relates generally to a plow assembly for cutting a slit in the ground. More particularly, this disclosure relates to a plow assembly having a rotating mass for creating vibrations which are transmitted to the plow blade to provide increased efficiency.

### BACKGROUND

Cables, conduits, and other services are often installed in relatively shallow underground trenches. For example, electrical lines (direct burial and/or conduit), telephone wiring/fiber optic, television cables, natural gas lines, and drainage lines are often buried in this manner. Additionally, drip irrigation lines and other types of conduits and lines can be installed underground. These lines, conduits, and pipes will be collectively referred to herein as “utility lines” for convenience.

These lines are often installed with a plow assembly, with such plows generally well-known in the art. Examples of such plows are described in U.S. Pat. No. 3,935,712; U.S. Pat. No. 4,102,403; and U.S. Pat. No. 4,337,712. These plows generally include a plow blade supported at the rear of the plow assembly. As used herein, the terms “front” and “rear” shall be with reference to the direction that the plow assembly moves during operation. As the plow blade is advanced through the ground, a narrow trench is created in which the utilities are laid. Initially, the act of creating the trench, installing the utility lines, and covering the trench were three separate acts. However, plow assemblies have advanced so that the utility lines are laid into the trench at the rear of the plow blade as the plow blade is advanced through the ground. Further, the plow assembly is designed such that any spoils from the trench are reintroduced into the trench and tamped by trailing tamping feet/wheels. In this manner, the utility lines are installed into the ground in a single pass over the ground by the plow assembly.

The energy needed to install utility lines depends on the desired depth, size of the utility lines, and the ground (soil) conditions (Clay, sand, loam, etc.). In hard conditions, the process may be slow and require a large amount of power from the tractor/plow assembly motor to pull the plow blade through the ground. To reduce this loading, various efforts have been made including injecting liquid to the plow blade and to the utility lines being installed to moisten and soften the ground. Other prior art plow assemblies have utilized rotating masses to impart a vibratory movement to the plow blade. However, even using these two methods, the rate at which the plow assembly can be advanced over the ground can still be relatively slow. Therefore, there is a need in the art for a method and apparatus for improving the efficiency in which the plow blade can be advanced through the earth. The present invention overcomes the shortcomings of the prior art.

### SUMMARY

The present disclosure generally relates to a method and apparatus for installing utility lines underground by using a vibratory plow. One aspect of the invention relates to using a resilient member attached to a vibrator assembly, where the resilient member stores the kinetic energy of the vibrator assembly downward movement. The kinetic energy is then released during the upward movement. The energy is applied to a plow blade so as to improve the efficiency of the plow blade as it is drawn through the ground. Another aspect of the invention relates to connecting the resilient member to the ground via a set of wheels that do not appreciably deflect during the downward movement.

While the invention will be described with respect to preferred embodiment configurations and with respect to particular devices used therein, it will be understood that the invention is not to be construed as limited in any manner by either such configurations or components described herein. Also, while particular types of special links are described herein, it will be understood that such particular mechanisms are not to be construed in a limiting manner. Instead, the principles of this invention extend to any environment in which kinetic energy is stored during the downward movement of the rotating masses and then utilized during the upward movement. These and other variations of the invention will become apparent to those skilled in the art upon a more detailed description of the invention.

The advantages and features which characterize the invention are pointed out with particularity in the claims annexed hereto and forming a part hereof. For a better understanding of the invention, however, reference should be had to the drawings which form a part hereof, and to the accompanying descriptive matter in which there is illustrated and described a preferred embodiment of the invention.

### BRIEF DESCRIPTION OF THE FIGURES

FIG. 1 is a side view of a plow assembly according to an embodiment of the present disclosure with the plow blade in the retracted position;

FIG. 2 is a side view of the plow assembly of FIG. 1 with the plow blade in an extended position;

FIG. 3 is an enlarged view of a portion of FIG. 2;

FIG. 4 is a perspective view of a portion of the plow assembly of FIG. 1;

FIG. 5 is a side view of the portion of the plow assembly shown in FIG. 4;

FIG. 6 is a cross-sectional view of the plow assembly along line 6-6 of FIG. 5;

FIG. 7 is a rear view of the portion of the plow assembly shown in FIG. 4;

FIG. 8 is a cross-sectional view of the plow assembly along line 7-7 of FIG. 7;

FIG. 9 is a front view of the portion of the plow assembly shown in FIG. 4;

FIG. 10A is a side schematic view of the plow assembly in a first position;

FIG. 10B is a side schematic view of the plow assembly in a second position;

FIG. 11 is a side schematic view of a first alternative embodiment of the plow assembly of FIG. 1;

FIG. 12 is a side schematic view of another alternative embodiment of the plow assembly of FIG. 1;

FIG. 13 is a side schematic view of another alternative embodiment of the plow assembly of FIG. 1;

FIG. 14 is a side schematic view of another alternative embodiment of the plow assembly of FIG. 1;

FIG. 15 is a side schematic view of another alternative embodiment of the plow assembly of FIG. 1;

FIG. 16 is a side schematic view of another alternative embodiment of the plow assembly of FIG. 1;

FIG. 17 is a side schematic view of another alternative embodiment of the plow assembly of FIG. 1;

FIG. 18 is a side schematic view of another alternative embodiment of the plow assembly of FIG. 1;

FIG. 19 is a side schematic view of another alternative embodiment of the plow assembly of FIG. 1; and

FIG. 20 is an enlarged portion of an alternative embodiment showing a torsion axle;

FIG. 21 is a side view of the torsion axle embodiment in a retracted position;

FIG. 22 is a side view of the torsion axle embodiment in an extended position;

FIG. 23 is an enlarged view of a portion of FIG. 22;

FIG. 24 is a perspective view of the torsion axle connected to the vibratory mechanism;

FIG. 25 is a rear view of the torsion axle connected to the vibratory mechanism;

FIG. 26 is a side view of the torsion axle connected to the vibratory mechanism;

FIG. 27 is a cross-sectional view along line 27-27 of FIG. 26; and

FIG. 28 is a cross-sectional view along line 28-28 of FIG. 25.

### DETAILED DESCRIPTION

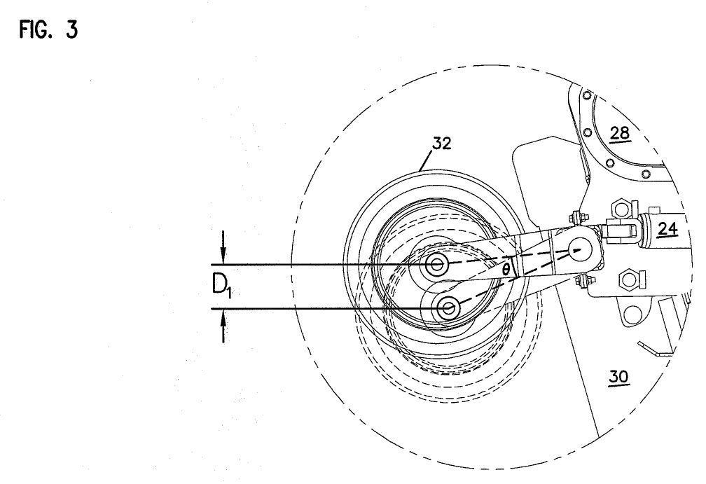

Referring to FIGS. 2 and 3, an embodiment of the vibratory plow system according to the present disclosure is shown. The system 10 includes a vehicle 12, a vibratory plow assembly 14, and a connection linkage 16 that connects the vibratory plow assembly 14 to the rear of the vehicle 12.

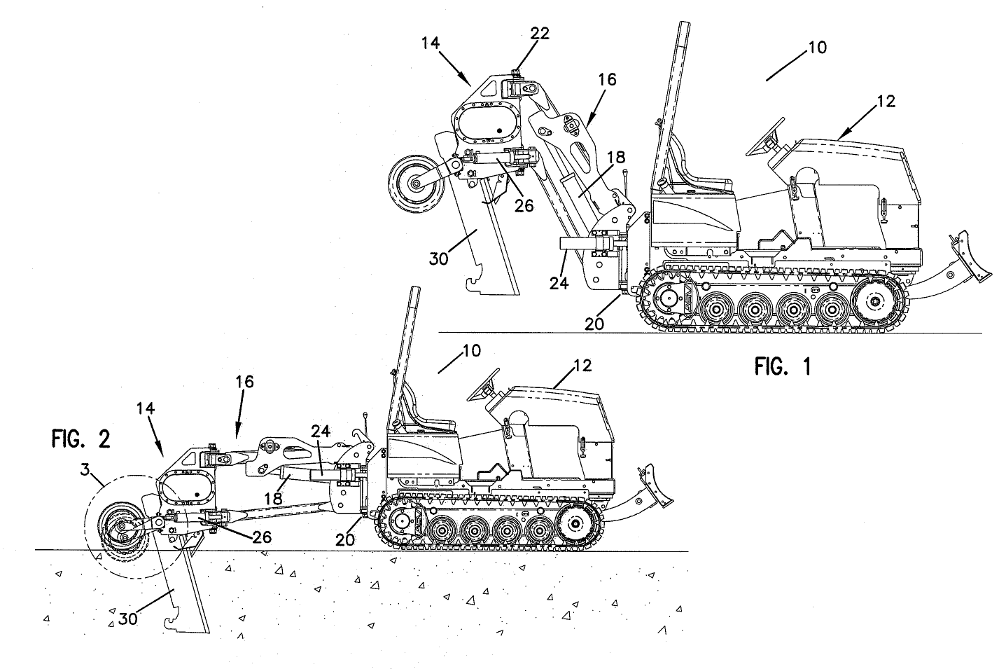

In the depicted embodiment the vehicle is a tracked machine, but it should be appreciated that in alternative embodiments many other types of vehicles may be used to drag the plow assembly. In the depicted embodiment the linkage 16 is a four bar type linkage that is actuated by a hydraulic cylinder 18 that extends and retracts the plow assembly 14. FIG. 1 shows the linkage 16 in the retracted position (disengaged position), and FIG. 2 shows the linkage 16 in the extended position (engaged position). In the depicted embodiment the linkage 16 is configured to pivot horizontally about the vehicle at the connection location 20 between the linkage 16 and the vehicle 12, and allow the plow assembly 14 to pivot about the linkage 16 about the connection location 22. Hydraulic cylinders 24 and 26 are provided for actuation of the linkage 16 relative to the vehicle 12 and the linkage 16 relative to the plow assembly 14. It should be appreciated that may other linkage configurations are also possible.

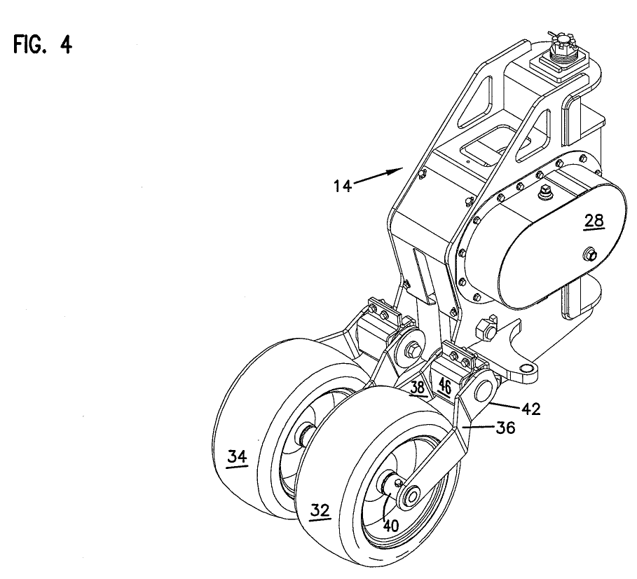

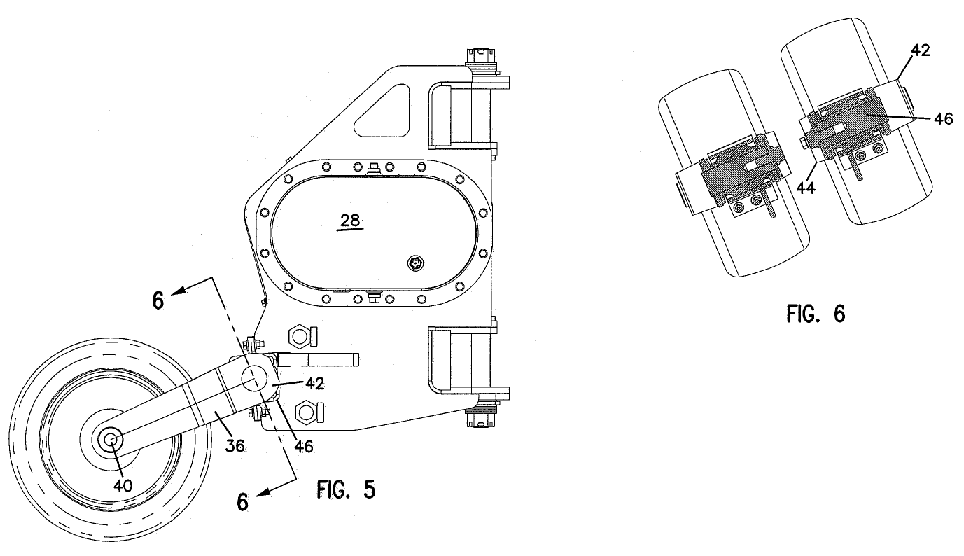

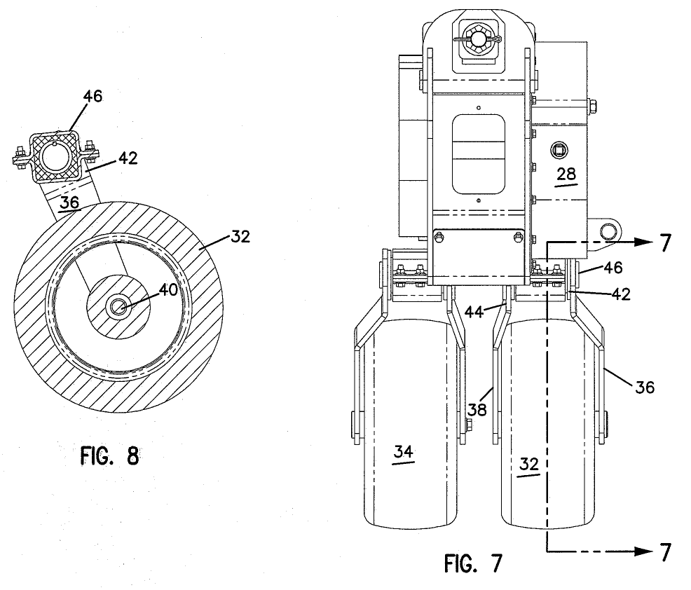

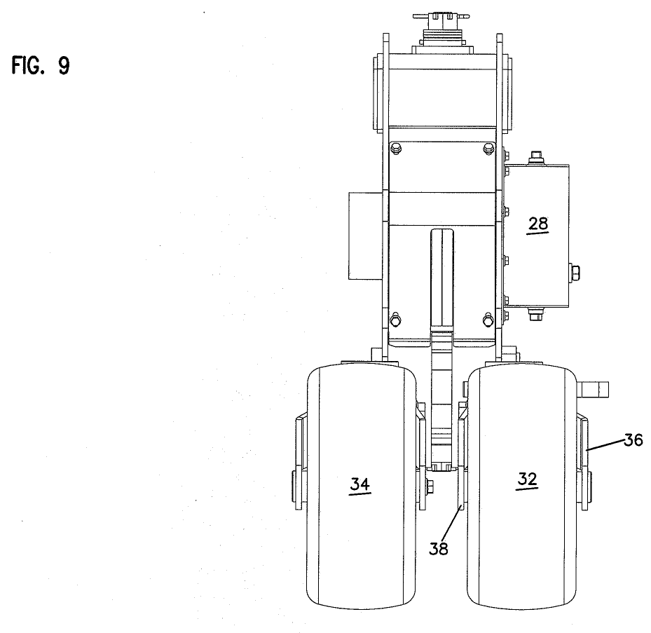

Referring to FIGS. 3-9 the plow assembly 14 is shown in greater detail. In the depicted embodiment the plow assembly 14 includes a vibration device 28 that is configured to be attached to the linkage 16, a plow blade 30, and two adjacent rollers 32, 34. The use of two adjacent rollers can be advantageous over a single roller in some embodiments as cables can be easily attached to the plow blade 30 via the gap between the rollers. However, it should be appreciated that any other number of rollers may be included in alternative embodiments of the present disclosure.

The rollers 32, 34 of the depicted embodiment are connected to the vibration device in an identical manner, and can move independent from each other. For simplicity, the connection assembly for only one of the rollers 32, 34 will be described herein. In the depicted embodiment, the roller 32 is connected to the lower portion of the vibration device 28 via a pair of pivot arms 36, 38. The distal ends of the pivot arms 36, 38 are connected to the axel 40 and the proximal ends 42, 44 of the pivot arms 36, 38 are connected to the vibration device 28. In the depicted embodiment the proximal ends are connected to a torsion bushing 46. It should be appreciated that in alternative embodiment the torsion bushing could be replaced with a torsion axle.

In the depicted embodiment the torsion bushing 46 and pivot arms 36, 38 are configured to accommodate a significant amount of vertical displacement, (also known as travel). In the depicted embodiment the travel is be between about 0 to 4 inches. More preferably, the travel is between about ½-1 inches. In the depicted embodiment the plow blade 30 is directly mounted to the vibration device 28. It should be appreciated that in other embodiments the plow blade 30 is mounted to the vibration device in a manner that allows the blade 30 to move relative to vibration device 28. In the depicted embodiment the vertical displacement of the vibration device 28 can be caused by the vibrations generated by the vibration device 28 in the vertical direction and/or caused by the plow blade 30 moving in the vertical direction as the plow blade 30 comes into contact with rocks and other materials in the ground.

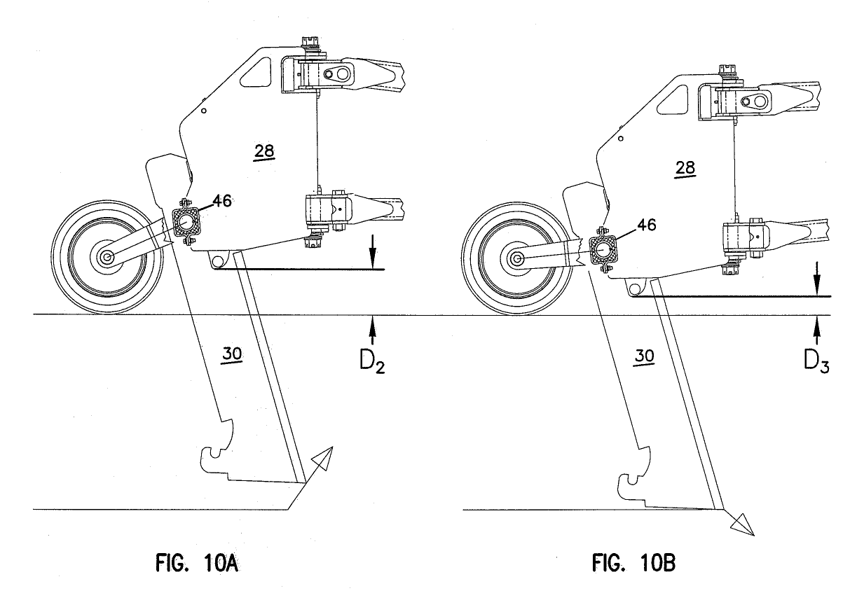

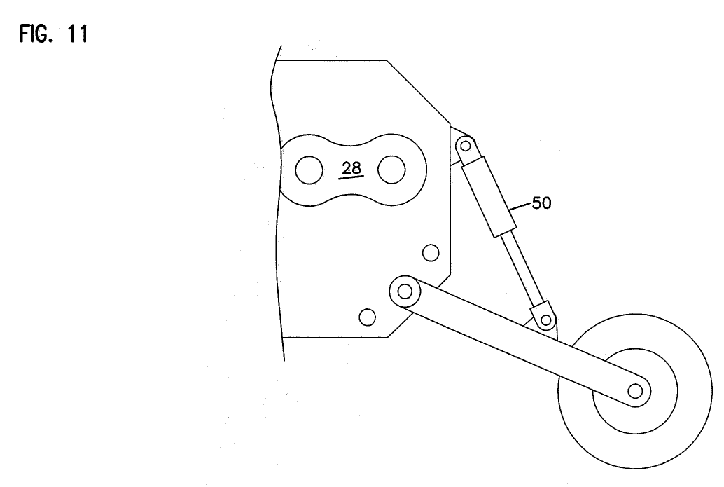

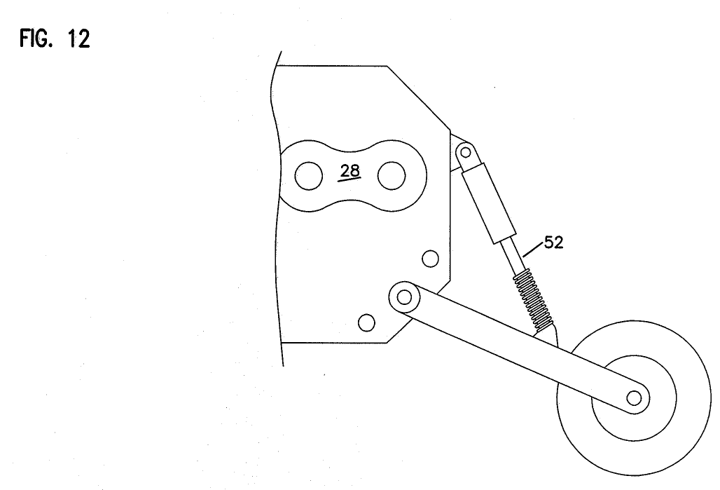

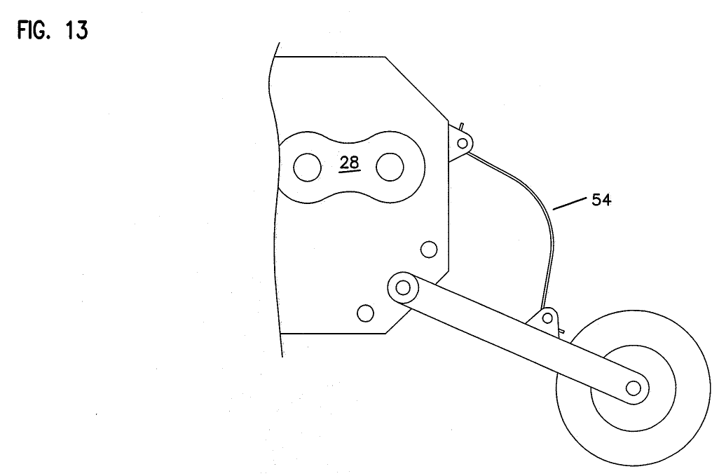

Referring to FIGS. 10A and 10B, the movement of the pivot arms 36, 38 are shown relative to the vibration device 28 and plow blade 30. When the plow blade 30 and vibration device 28 are in the peak position (relative high position) as in FIG. 10A, the energy stored in the torsion bushing 46 is release. Conversely, when the plow blade 30 and the vibration device 28 move in valley (relative low position) as in FIG. 10B, the energy is loaded into the torsion bushing 46. The vertical movement to plow blade 30 oscillates from peaks to valleys.

The configuration of the present disclosure results in a smoother, more efficient cut through the ground as it does not significantly dampen the vibration in the lateral direction and more efficiently uses the vibrations in the vertical direction. To provided a quantitative measure of some of the performance advantages associated with the present disclosure, a prior art vibratory plow system was compared to a comparably side by side with a powered system that incorporated features of the present disclosure.

In particular, the performance of a prior art vibratory plow with tamping feet and without a torsion bushing in the configuration described above was measured. Based on five trial runs the average feet per minute was 15.5 feet/min with a standard deviation of 9.5 feet/min. The performance of a comparably powered vibratory plow system with the above described rollers and torsion bushing was also measured. Based on five trial runs the average feet per minute was 115.4 feet/min with a standard deviation of 20.0 feet/minute. In view of the above test, it is evident that present disclosure provides a significantly faster system as compared to the prior art. It is believed that the improved performance is in part a result of the plow blade having more energy on the up stroke. It should be appreciated that the relative performance advantages associated with the plow system of the present disclosure over prior art systems is most evident in compressed soil conditions (i.e., difficult to plow soil). In compressed soil condition, the plow system according to the present disclosure imparts relatively less load on the pulling vehicle than system of the prior art.

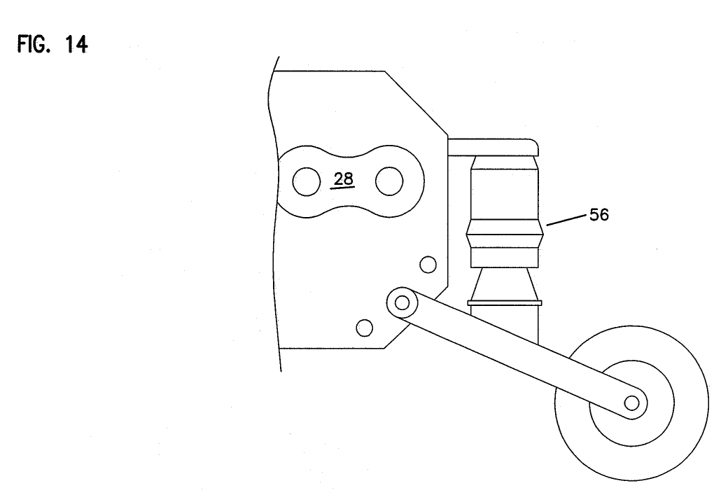

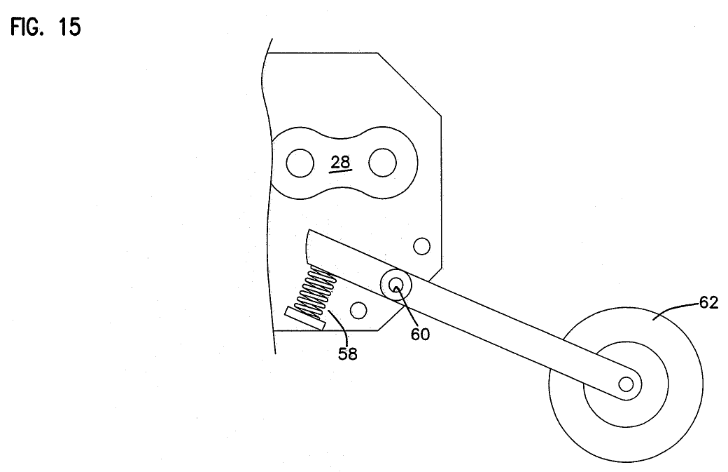

Referring to FIGS. 11-19, other alternative embodiments of the present disclosure are shown. FIG. 11 illustrates an embodiment that includes a cylinder 50 (e.g., air, hydraulic) that can be used in place of or in conjunction with the torsion bushing. FIG. 12 illustrates an embodiment that includes a cylinder and spring arrangement 52 that can be used in place of or in conjunction with the torsion bushing. FIG. 13 illustrates an embodiment that includes a leaf spring arrangement 54 that can be used in place of or in conjunction with the torsion bushing. FIG. 14 illustrates an embodiment that includes an air bag arrangement 56 that can be used in place of or in conjunction with the torsion bushing. FIG. 15 illustrates an embodiment that includes a spring arrangement 58 that can be used in place of or in conjunction with the torsion bushing. In the depicted embodiment the spring is located on the opposite side of the pivot point 60 between the roller 62 and the vibration device.

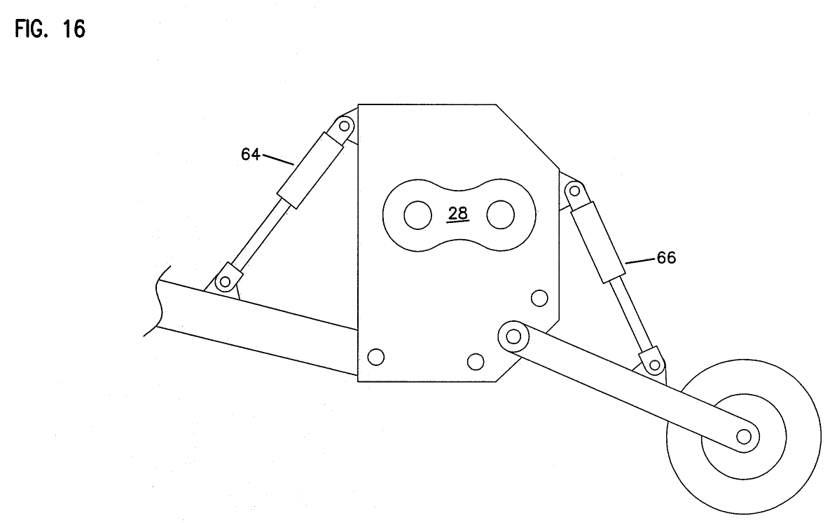

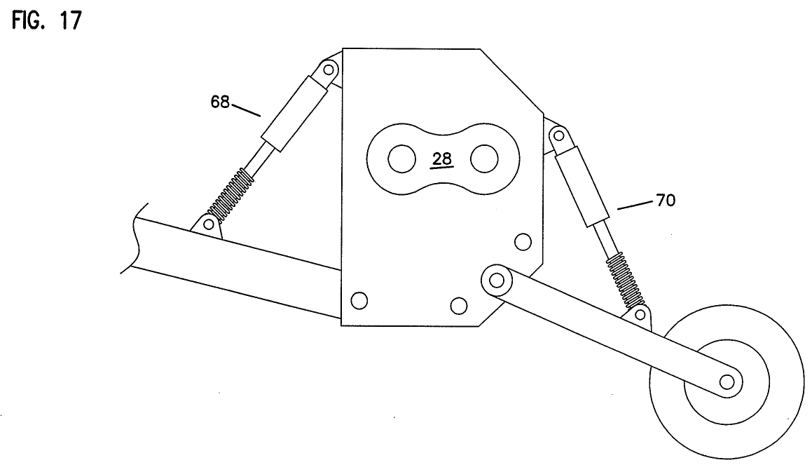

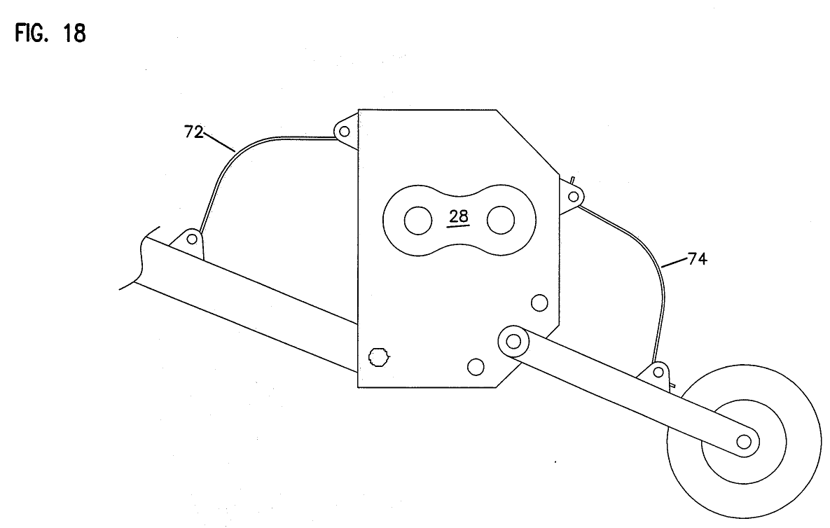

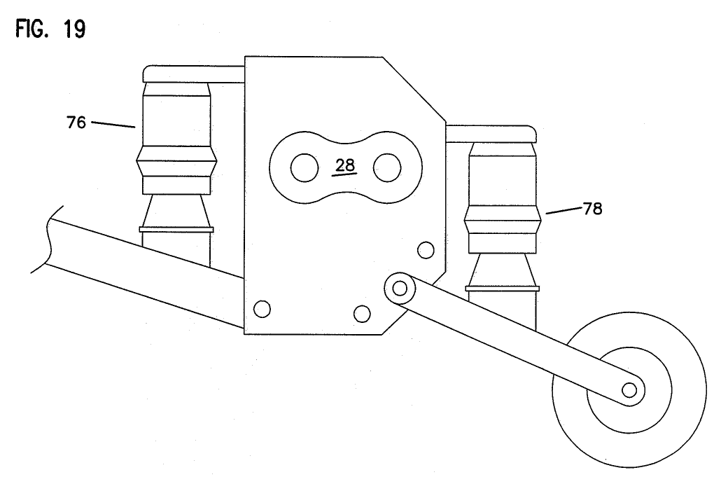

FIG. 16 illustrates an embodiment that includes a pair of cylinders 64, 66 located on either side of the vibration device 28 that can be used in place of or in conjunction with the torsion bushing. FIG. 17 illustrates an embodiment that includes a pair of cylinders and spring arrangements 68, 70 located on either side of the vibration device 28 that can be used in place of or in conjunction with the torsion bushing. FIG. 18 illustrates an embodiment that includes a pair of leaf springs 72, 74 located on either side of the vibration device 28 that can be used in place of or in conjunction with the torsion bushing. FIG. 19 illustrates an embodiment that includes a pair of air bags 76, 78 located on either side of the vibration device 28 that can be used in place of or in conjunction with the torsion bushing.

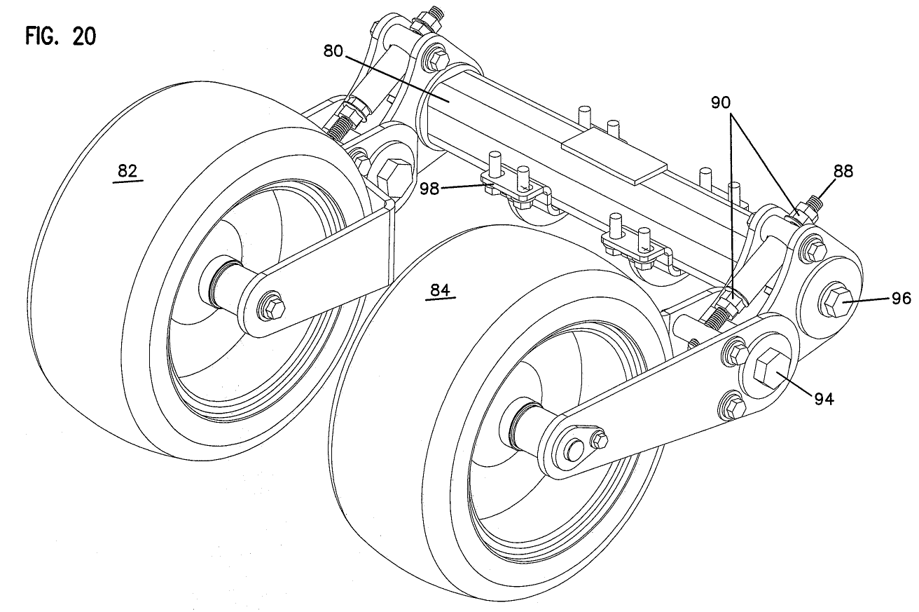

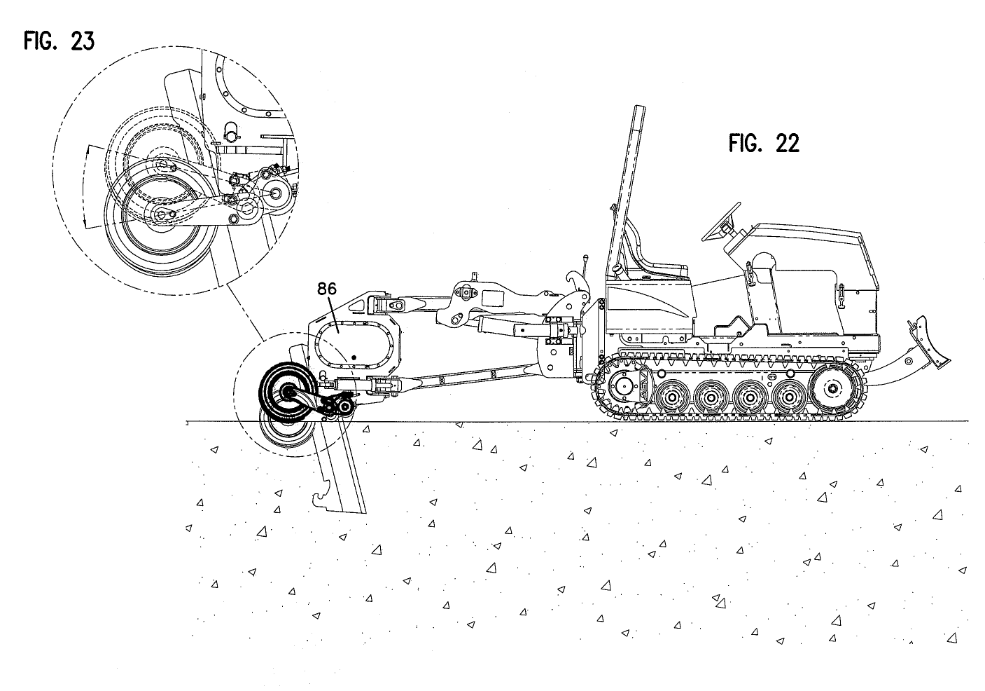

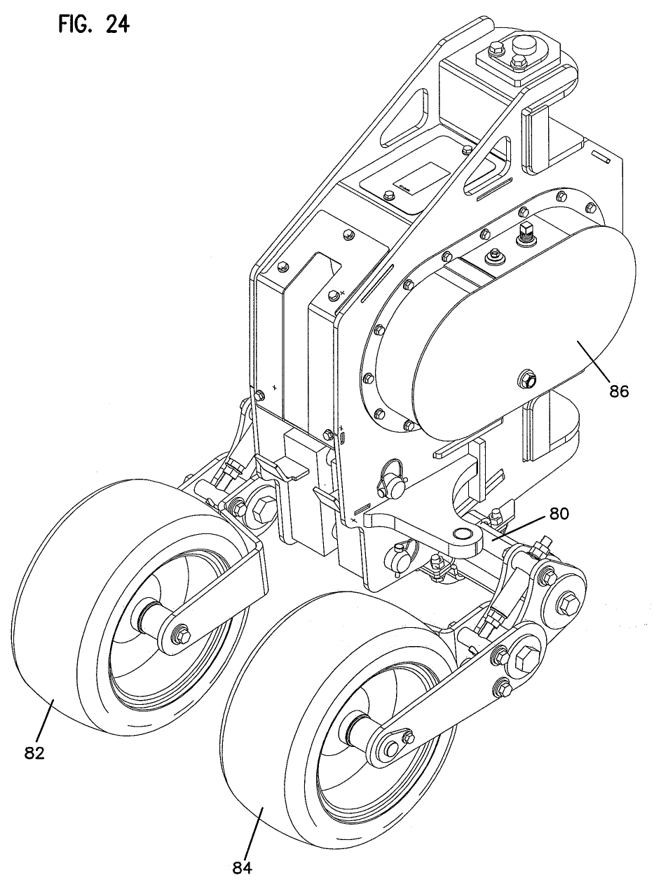

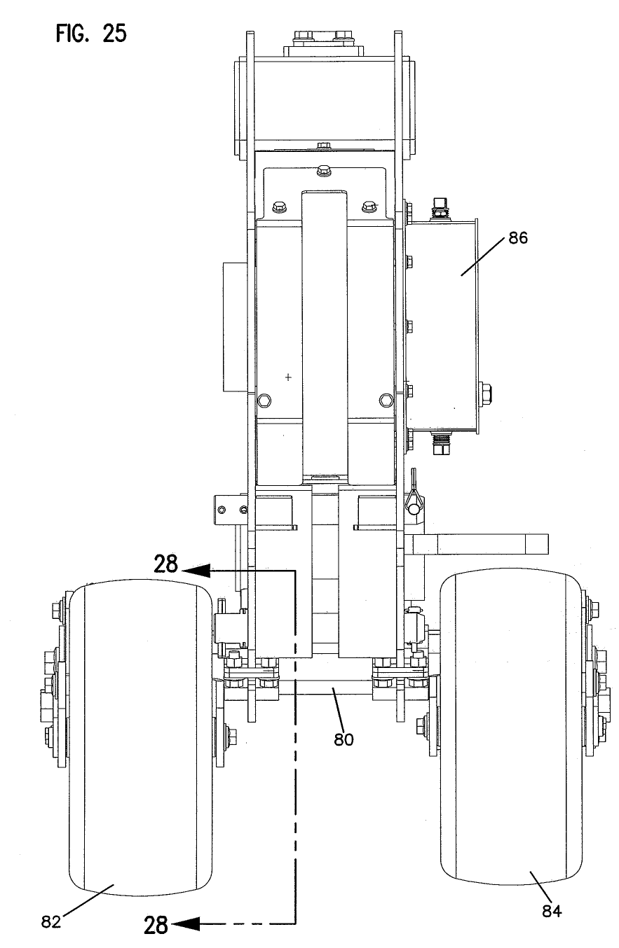

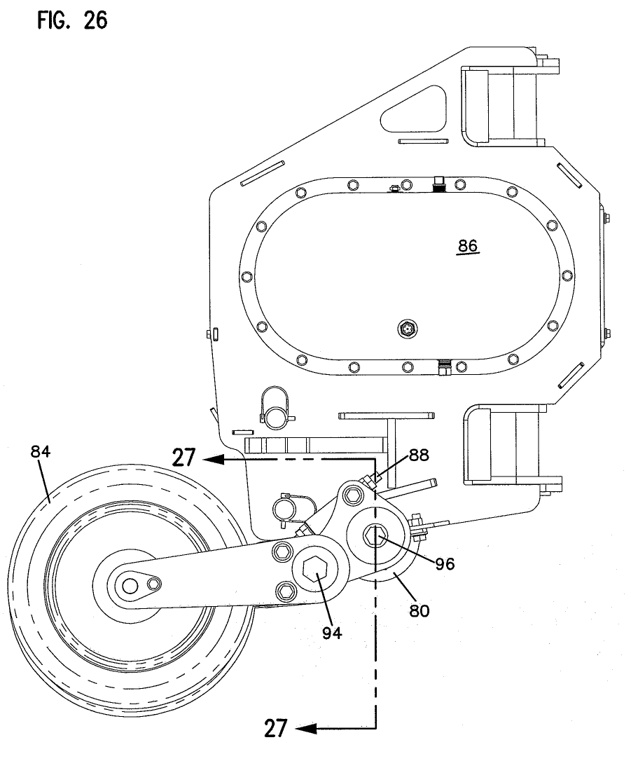

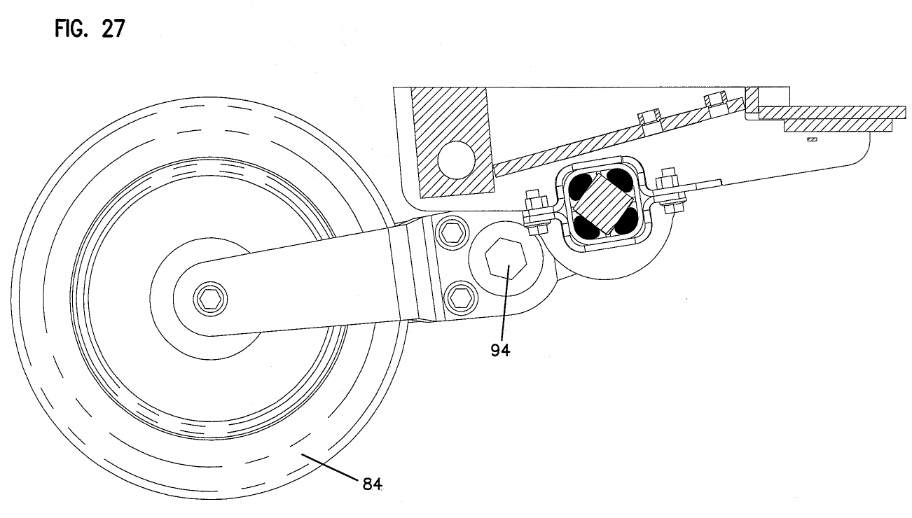

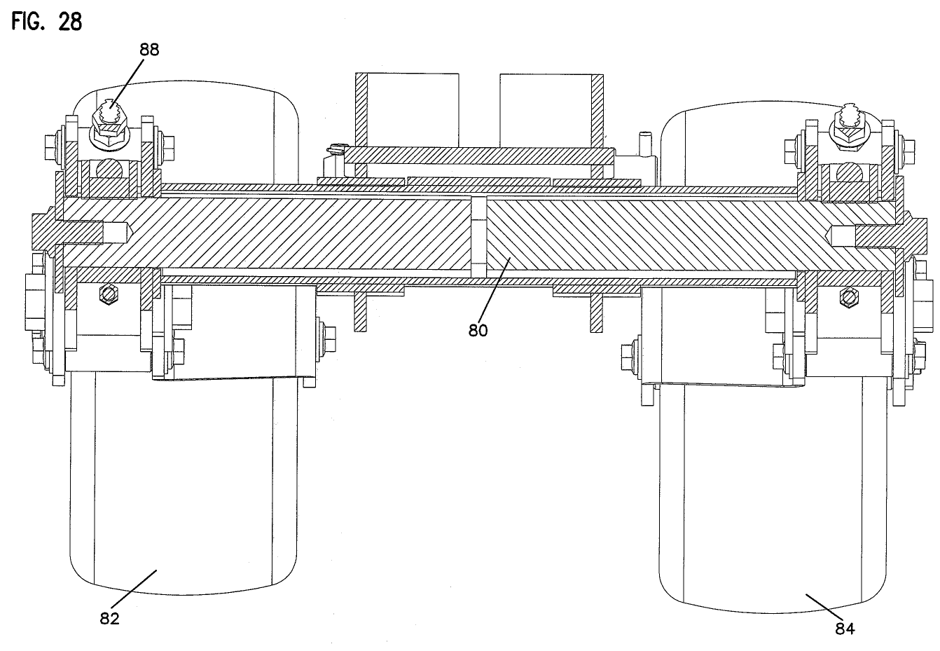

Referring to FIGS. 20-28 shows an embodiment of the plow system with a torsion axle 80 in place of the torsion bushing 46. In the depicted embodiment the torsion axle 80 connects the wheels 82, 84 to the vibratory device 86. In the depicted embodiment the torsion axle is a resilient member that interfaces between the wheels and the vibratory device. In the depicted embodiment, the position between the wheels 82, 84 and the torsion axis can be adjusted via adjustment nuts 90 on bolts 88. Adjusting the adjustment nuts 90 pivots the wheels 82, 84 about the adjustment pivot axis 94. Once the adjustment nuts 90 are set the wheels 82, 84 are arranged to pivot about the main pivot axis 96 in use. In the depicted embodiment the torsion axle 80 is mounted to the vibratory device 86 via a bracket assembly 98. It should be appreciated that in alternative embodiments, the embodiments including torsion axles can be configured in many alternative arrangements.

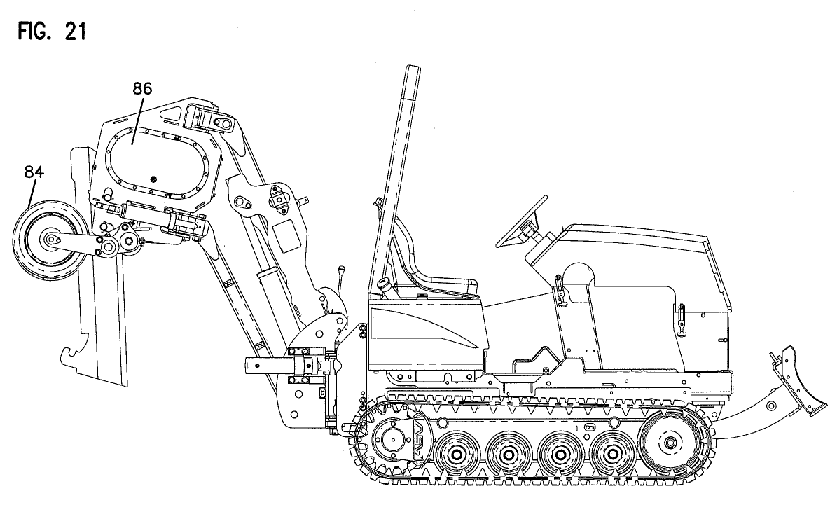

Referring to FIGS. 21-28, the above-described embodiment including a torsion axle is shown as part of a complete plow system. Many of the features are similar to the features of the above-described system; therefore, they are not described again herein.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A vibratory plow system comprising:
a vehicle;
a plow frame attached to the rear of the vehicle;
a vibration device connected to the plow frame;
a plow blade connected to the plow frame;
a roller connected to the plow frame behind the plow blade, wherein the roller is configured to pivot upward when the plow blade moves downward and pivot downward when the plow blade moves upward; and
a resilient member positioned between the roller and vibration device to allow the roller to automatically pivot.

2. The system of claim 1, wherein the plow blade is mounted to the vibration device and the roller is mounted to the vibration device.

3. The system of claim 2, wherein the vibratory plow comprises two rollers mounted to the vibration device adjacent each other, wherein both rollers are configured to pivot upward when the plow blade moves downward and pivot downward when the plow blade moves upward, and wherein both rollers can pivot upwards and downward independent of each other.

4. The system of claim 1, wherein the roller is a ridged type solid tire.

5. A vibratory plow assembly comprising:
a vibration device configured for vibrating a plow blade;
a roller connected to the vibration device configured to contact a ground surface and pivot relative to the vibration device; and
a resilient member positioned between the roller and vibration device configured to store vibration energy when the roller is pivoted in a first direction and release the energy when the roller is pivoted in a second direction.

6. The assembly of claim 5, further comprising a plow blade mounted to the vibration device.

7. The assembly of claim 5, wherein the axis of the roller is configured to travel at least one inch in the vertical direction relative to a pivot connection between the second end of the pivot arm and the vibration device.

8. The assembly of claim 7, wherein the axis of the roller is configured to travel at least four inches in the vertical direction relative to a pivot connection between the second end of the pivot arm and the vibration device.

9. The assembly of claim 5, further comprising a pivot arm including a first end that supports the roller and a second end that is pivotally connected to the vibration device.

10. The assembly of claim 9, wherein the resilient member comprises a torsion bushing located at the connection between the second end of the pivot arm and the vibration device.

11. The assembly of claim 9, wherein the resilient member comprises a torsion axle located at the connection between the second end of the pivot arm and the vibration device.

12. The assembly of claim 9, wherein the resilient member is attached to the pivot arm between the first end and second end.

13. The assembly of claim 5, wherein the resilient member comprises a gas cylinder.

14. The assembly of claim 5, wherein the resilient member comprises a coil spring.

15. The assembly of claim 5, wherein the resilient member comprises an air spring.

16. The assembly of claim 5, wherein the resilient member is leaf spring.

17. A method of creating a slit in the ground surface comprising:
driving a plow blade through the ground while vibrating the plow blade, wherein the blade moves in an upward and downward direction; and
storing the kinetic energy from the downward vibration and automatically releasing the energy during an upward movement of the plow blade.

18. The method of claim 17, wherein the energy is stored in a torsion spring.

19. The method of claim 17, wherein the step of storing and releasing energy maintains downward pressure on the plow blade.

20. The method of claim 17, wherein the storing step includes providing a substantially non-compressible wheel on the ground surface and connected to the plow blade.

21. The method of claim 17, wherein the wheel is a semi-pneumatic wheel.
